(19) United States
(12) Patent Application Publication
(10) Pub. No.: US 2002/0066449 A1
(43) Pub. Date: Jun. 6, 2002

(54) Steam-generating attachment for barbecue

(76) Inventor: William Walsh, Ajax (CA)

Correspondence Address: BIRCH STEWART KOLASCH & BIRCH, PO BOX 747, FALLS CHURCH, VA, 22040-0747, US

(21) Appl. No.: 09/995,620

(22) Filed: Nov. 29, 2001

(30) Foreign Application Priority Data
Dec. 1, 2000 (CA) 2 327 391

(51) Int. Cl. F24C 13/00; A47J 37/00

(52) U.S. Cl. 126/369; 126/41 R

(57) ABSTRACT

The steam-generating attachment includes an elongated perforated pipe adapted to be seated above the burner of an outdoor barbecue. A reservoir for water is connected to the pipe and is mounted ss that water will flow to the pipe. Water in the pipe is heated to the boiling point by the burner and escapes as steam from perforations in the pipe. The steam moistens the food which is cooking on a grill above the pipe. The flow of water to the pipe can be regulated in order to control the amount of steam in which the food is cooked.

### BACKGROUND OF THE INVENTION

This invention relates to attachments for outdoor barbecues and more particularly to a steam-generating attachment for moistening food while it is cooking on a barbecue. The invention also relates to barbecues furnished with such attachments.

Food which is cooked on a barbecue can be quite dry unless it is basted while it is being cooked. Usually the person who is doing the cooking must continuously baste the food as it is being cooked to avoid unacceptable dryness in the final product. It may not always be possible for the person to do so, one reason being that the gravy, marinate or whatever else is used for the basting may run out before the food is fully cooked. Another reason may be that the person cannot give his full attention to the task. Whatever the reasons, the result will be excessively dry food.

### SUMMARY OF THE INVENTION

I have found that food cooked on a barbecue can be continuously moistened as it is being cooked by means of a steam-generating attachment. The attachment may be used in conjunction with a conventional outdoor barbecue having a housing in which a burner is mounted. The attachment has a pipe which is placed above the burner. Water flows through the pipe and is heated by the burner and escapes as steam from perforations in the pipe. The steam moistens the food which is cooking on a grill above the pipe. The flow of water to the pipe can be regulated in order to control the amount of steam in which the food is cooked.

Food cooked in a barbecue having such an attachment is moist whether or not it is basted while it is being cooked. The person doing the cooking need not devote all his attention to the task. He may attend to other matters while the food cooks without impairing the quality of the finished product.

Briefly, the steam-generating attachment includes an elongated perforated pipe adapted to be seated above the burner of the barbecue. A reservoir for water in liquid flow relationship to the pipe is also part of the attachment. The reservoir is mounted such that the water flows to the pipe.

### DESCRIPTION OF THE DRAWINGS

The steam-generating attachment of the invention is described with reference to the accompanying drawings in which:

FIG. 1 is a perspective view of a conventional outdoor barbecue in combination with the attachment of the invention. One component of the steam-generating attachment is shown detached from the other components;

FIG. 2 is another perspective view of the barbecue and steam-generating attachment. The component shown detached in FIG. 1 is shown attached in FIG. 2;

FIG. 3 is a side elevation, partly cut away, of the barbecue and steam-generating attachment;

FIG. 4 is a front elevation of the steam-generating attachment and the barbecue, shown partly cut away;

FIG. 5 is a schematic representation of a second embodiment of the steam-generating attachment of the invention; and

FIG. 6 is a schematic representation of a third embodiment of the steam-generating attachment.

Like reference characters refer to like parts throughout the description of the drawings.

### DESCRIPTION OF PREFERRED EMBODIMENTS

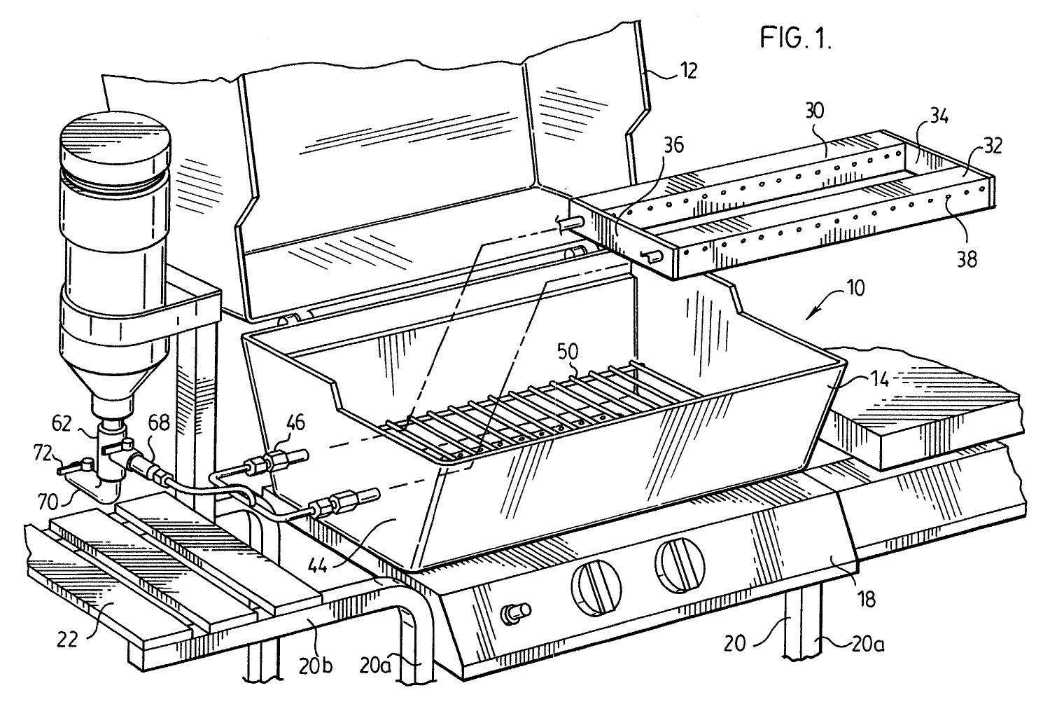

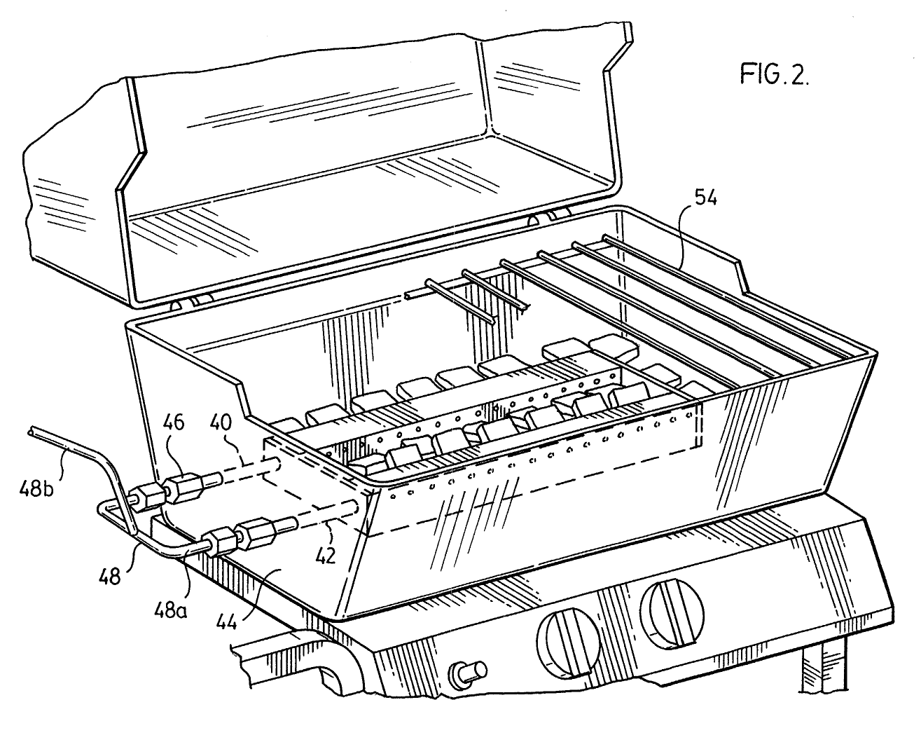

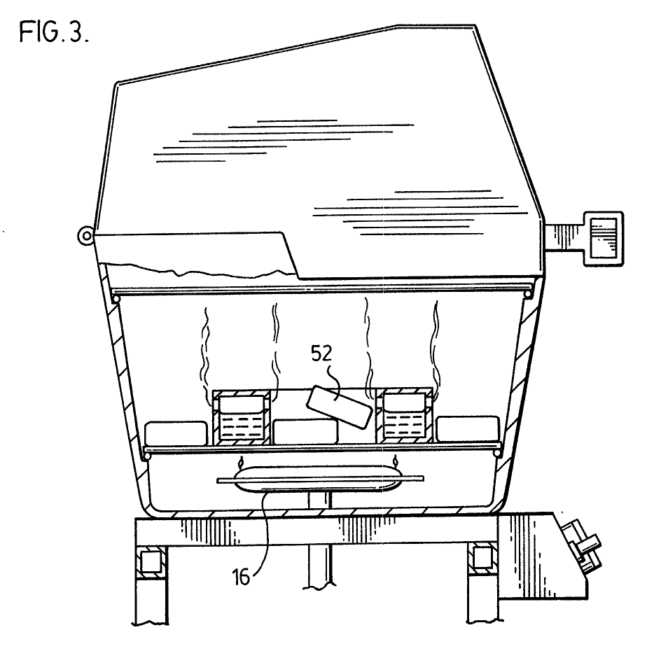

With reference to FIGS. 1 to 3, a barbecue of conventional construction is depicted and indicated generally 10. The barbecue has a lid 12 and a housing 14 in which a burner 16 (FIG. 3) is located. The barbecue is mounted on a trolley 18 having a leg 20 at each corner.

Each leg has a downwardly extending extent 20a which supports the trolley and a horizontally extending extent 20b which serves as the frame for table 22. The table and another like it extend horizontally outward from each side of the barbecue.

The steam-generating attachment of the invention includes two pipes 30, 32 which are spaced apart and are closed by spacers or plates 34, 36 at opposite ends of each. The pipes are perforated along their side walls at 38 and are in liquid-flow communication with tubes 40, 42. The tubes extend outwardly from one end of each pipe and through openings in the side wall 44 of housing 14. The tubes are connected by means of threaded couplings 46 to a conduit 48. The conduit is in two parts, a horizontal U-shaped part 48a and an upwardly extending part 48b.

Perforated pipes 30, 32 rest upon a lower grill 50 which is supported by ridges (not illustrated) in the front and rear walls of the housing. The perforated pipes are above the burner and are heated by it.

Briquettes 52 are arranged on both sides of the perforated pipes and in the space between the two perforated pipes.

An upper grill 54 is disposed above perforated pipes 30, 32. Food to be cooked on the barbecue is placed on the upper grill as is conventional.

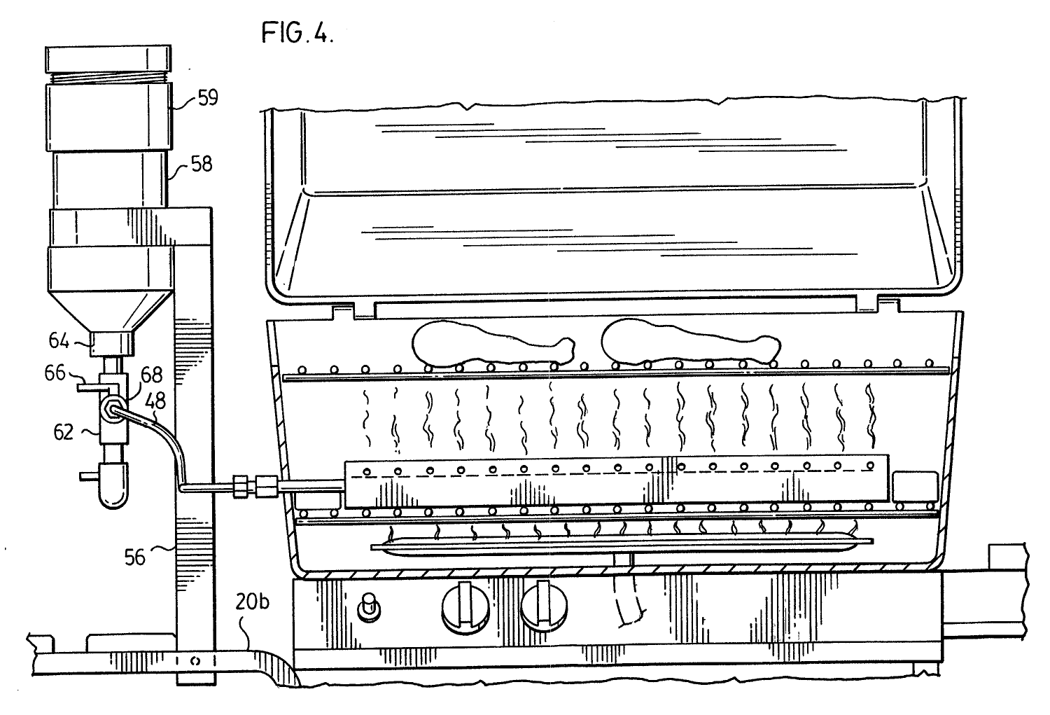

With reference to FIGS. 1 and 4, a post 56 is removably connected by means of a conventional clamp (not illustrated) to horizontally extending extent 20b of one leg. A bottle or reservoir 58 is clamped to the post. The bottle has a cap 59 which can be removed so that water can be added to the bottle.

The bottle is turned upside down and one leg of a T-joint 62 is threadably connected in the neck 64 of the bottle. A valve operated by handle 66 is connected to a second leg of the T-joint and a coupling 68 threadably interconnects that leg to conduit 48. The flow of water to the perforated pipes can be regulated by means of the valve in order to control the amount of steam in which the food is cooked.

The third leg of the T-joint is connected to L-shaped conduit 70 and a valve operated by handle 72 opens and closes that conduit. Opening of the valve allows the bottle to be drained.

When the steam-generating attachment of the invention is not required in the barbecue, it is removed by first closing handle 66, then disconnecting couplings 46 to free tubes 40, 42 from conduit 48. The clamp connecting post 56 to the barbecue is then loosened so that the post can be removed from the barbecue. Perforated pipes 30, 32 are then removed from the interior of the housing.

When the steam-generating attachment is required, the steps described in the previous paragraph are reversed. Handle 66 is then used to open the valve to allow water to flow from the bottle to the perforated pipes. When the burner is activated, the water in the perforated pipes will be heated and escape through perforations in the pipes as steam. As the steam rises it moistens any food on the upper grill.

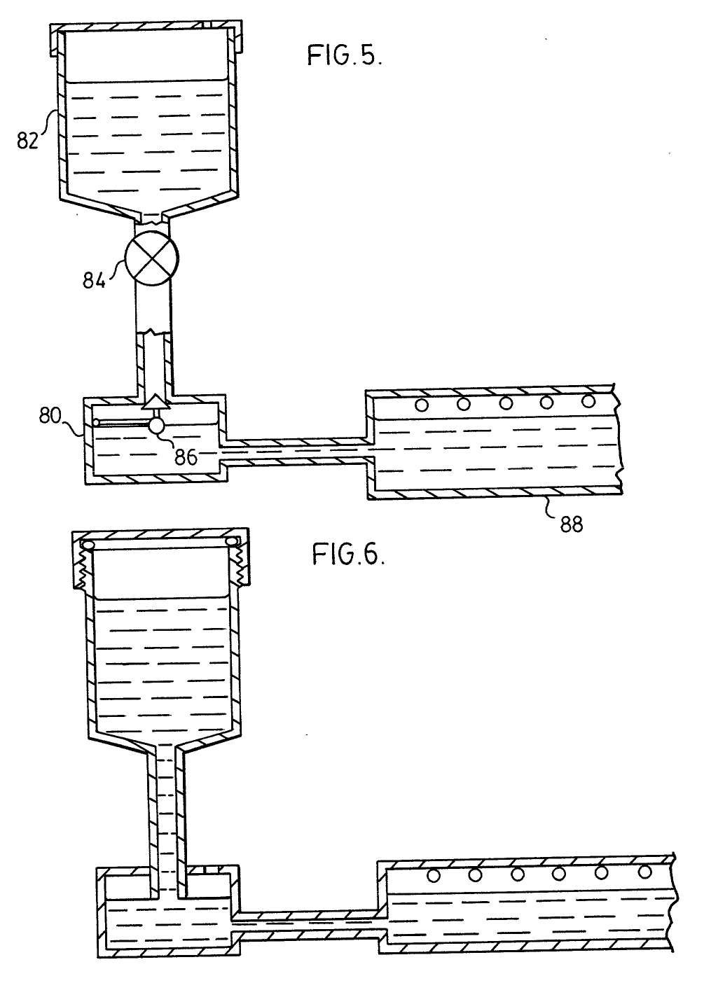

With reference to FIG. 5, the illustrated steam-generating attachment includes a tank 80 into which water from bottle 82 flows. A valve 84 is provided for controlling the flow. A float valve 86 within the tank controls the level of water in the tank.

Water from tank 80 flows to perforated pipes 88 where it is heated by the burner of a barbecue. The float valve controls the level of water in the perforated pipes.

With reference to FIG. 6, the level of water within the perforated pipes will rise until the water completely fills the perforated pipes . The steam-generating attachment lacks means by which the level of water can be adjusted so that it is below that level. That steam-generating attachment differs from the steam-generating attachment illustrated in FIG. 5 in this respect.

It will be understood, of course, that modifications can be made in the steam-generating attachment illustrated and described herein without departing from the scope and purview of the invention as defined in the appended claims.

I claim:

1. A steam-generating attachment for a portable barbecue having a housing within which a burner is mounted, said attachment including an elongated perforated first pipe adapted to be seated above said burner; a reservoir for water in liquid flow relationship to said pipe; means for mounting said reservoir such that water is adapted to flow from said reservoir to said pipe.

2. The steam-generating attachment as claimed in claim 1 further including a second perforated pipe in liquid flow relationship to said reservoir and adapted to be seated above said burner; and at least one spacer for maintaining said first and second perforated pipes in a spaced parallel relationship.

3. The steam-generating attachment as claimed in claim 1 further including means for adjusting the rate of flow of water from said reservoir.

4. The steam-generating attachment as claimed in claim 1 wherein said mounting means includes a post to which said reservoir is attached; and a clamp for removably attaching said post to said housing.

5. The steam-generating attachment as claimed in claim 1 further including a conduit connected to said reservoir and said first pipe and through which water flows from said reservoir to said first pipe; a valve for controlling the rate of flow of water through said conduit; a post to which said reservoir is attached; a clamp for removably attaching said post to said housing; and means for disconnecting said conduit from one of said reservoir and said pipe to facilitate the selective connection of said attachment to said barbecue and the removal therefrom.

6. The steam-generating attachment as claimed in claim 6 further including a tank through which water flows from said reservoir to said first pipe; and a float valve for controlling rate at which water enters said tank from said reservoir according to the level of water in said tank.

7. The combination as claimed in claim 6 further including a float valve for adjusting the rate at which water enters said tank from said reservoir according to the level of water in said tank.

8. In combination, a portable barbecue having a housing within which a burner is mounted and a steam-generating attachment, said attachment including an elongated perforated first pipe adapted to be seated above said burner; a reservoir for water in liquid flow relationship to said pipe; means for mounting said reservoir such that water is adapted to flow from said reservoir to said perforated pipe.

9. The combination as claimed in claim 8 further including a second perforated pipe in liquid flow relationship to said reservoir and adapted to be seated above said burner; and at least one spacer for maintaining said first and second perforated pipes in a spaced parallel relationship.

10. The combination as claimed in claim 8 further including means for adjusting the rate of flow of water from said reservoir.

11. The combination as claimed in claim 8 wherein said mounting means includes a post to which said reservoir is attached; and a clamp for removably attaching said post to said housing.

12. The combination as claimed in claim 8 further including a conduit connected to said reservoir and said first perforated pipe and through which water flows from said reservoir to said first pipe; a valve for controlling the rate of flow of water through said conduit; a post to which said reservoir is attached; a clamp for removably attaching said post to said housing; and means for disconnecting said conduit from one of said reservoir and said pipe to facilitate the selective connection of said attachment to said barbecue and the removal therefrom.

13. The combination as claimed in claim 8 further including a tank through which water flows from said reservoir to said first pipe; and a float valve for controlling rate at which water enters said tank from said reservoir according to the level of water in said tank.

14. The combination as claimed in claim 8 further including a float valve for adjusting the rate at which water enters said tank from said reservoir according to the level of water in said tank.
